(19) United States
(12) Patent Application Publication
(10) Pub. No.: US 2004/0003078 A1
(43) Pub. Date: Jan. 1, 2004

(54) Component management framework for high availability and related methods

(76) Inventors: Charlene J. Todd, Chandler, AZ (US); Todd R. Leasher, Scottsdale, AZ (US); Nick Ramirez, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/183,894

(22) Filed: Jun. 26, 2002

(51) Int. Cl. G06F 15/173

(52) U.S. Cl. 709/224

(57) ABSTRACT

Described herein is a component management framework for high availability and related methods.

### TECHNICAL FIELD

The invention generally relates to the field of high availability systems and more particularly to a component management framework for high availability.

### BACKGROUND

Critical computing, networking, and communications applications need to be highly reliable and continuously available. For example, many commercial applications use the Internet for continuous availability of service. The communications infrastructure supporting the Internet must be reliable and accessible to meet the demands of the critical applications and of the users who expect services to be available at all times. Likewise, there is an expectation of extraordinary dependability and availability for telecommunications systems, local area networks, personal computers, television and stereo systems, automotive and aviation electronics, and a host of other electronic devices that may incorporate a computing device.

“Reliability” as applied to technology is sometimes defined as an attribute of dependability, that is, a measure of the continuous delivery of a service in the absence of failure. Reliability is most often represented as a probabilistic number or formula that estimates the average or mean time to failure (MTTF). By definition, the use of this measure implies limited confidence in the technology since it is based on the likely probability of failure.

“Availability,” which is another attribute of dependability is a measure of the probability that a service is available for use at any given instant. Availability provides for some service failure, taking into account the amount of time until service restoration can be performed, or mean time to repair (MTTR). In this regard, availability may be described mathematically as:

Availability=MTTF/(MTTF+MTTR). (1)

“High availability” (HA) is a term used between artisans in the electronic arts and is used to refer to a system that is capable of providing service most of the time. HA can be attained, therefore, by creating very reliable components (high MTTF) or by creating elements that can recover from failure or be repaired very quickly (low MTTR). As the MTTR approaches zero in the above formula, availability approaches 1, that is, 100% availability.

Provision of highly reliable systems for HA has been a longstanding problem. Various schemes have been used to provide the desired reliability and availability. For example, components making up a system can adhere to ultra-strict design tolerances and can be manufactured from the best materials using the highest quality control. Such a scheme is appropriate for components used in space satellites and life-support systems, but can be prohibitively expensive to implement for consumer electronic devices.

Fault tolerance and redundant provisioning of subsystems is another design technique that can impart HA. Components within a system can be replicated so that the function of the system is carried out simultaneously in different parts or, if a subsystem fails, the process it performs is carried out by a “spare.” Similarly, “clustering” is another HA scheme. When several independent systems are available, they can be coupled so that if one system fails, its task is passed to one of the other independent systems. This is sometimes used for computing systems that can be linked to common data and application servers. However, this scheme raises security issues, and is often expensive and complex. Additionally, if the independent systems are substantially identical, the fault that causes a failure in one system may cause a failure in all.

Attempts have been made to increase the number and capability of open architecture HA computing systems. These conventional methods usually adopt existing standards to create a single software component model and a hardware architecture that work together. The existing standards, however, do not allow for the integration, substitution, and management of heterogeneous components. Changes to existing HA systems require significant retrofitting and reengineering, which becomes more burdensome as the HA system becomes more complex. Thus, conventional HA systems are limited to proprietary products or locked into specific layers, such as the operating system layer, the management middleware layer, the hardware platform layer, programming languages, software object models, or distribution frameworks for known components and systems with known interactions. Thus, conventional HA management provides no consistency across elements that participate on different layers in a system.

In particular, telecommunications equipment providers have conventionally developed and integrated complete systems internally, a process that took several years and hundreds of resource years to complete. These systems achieved a six-sigma availability level (i.e., 99.999% system availability), equivalent to about 5 minutes of down time per year across the entire system. However, no longer is five nines (99.999%) system availability enough, users are expecting continuous service availability, that is, connections that are maintained without disruption regardless of hardware, software, or operator-caused faults.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a block diagram of an example electronic system environment incorporating an embodiment of the invention;

FIG. 2 is a block diagram of an example system manager, example component management entities (CMEs), and example components coupled together into a component management framework for high availability, according to one embodiment of the invention;

FIG. 3 is a block diagram of example CMEs, according to one embodiment of the invention;

FIG. 4 is a flowchart of an example method embodiment of the invention;

FIG. 5 is a flowchart of an example method of coupling a system manager and a CME with a component, according to one embodiment of the invention;

FIG. 6 is a graphical representation of an article of manufacture, comprising a machine-accessible medium containing a class library, wherein the class library expresses attributes and methods of an embodiment of the invention; and

FIG. 7 is a graphical representation of an article of manufacture, comprising a machine-accessible medium containing data, that when accessed cause a machine to perform a method of the invention or to create a module or software object of the invention.

### DETAILED DESCRIPTION

Described herein in its several embodiments, is an invention providing high availability, and related methods. Various embodiments of the invention, developed more fully below, provide and interface to monitor and control one or more various resources (components) of an electronic system to ensure that the system is available substantially all of the time. In this regard, the interface introduced herein renders a host system a highly available system, in accordance with the teachings of the invention. The components may be a heterogeneous mix of hardware, software, or both and may belong to many different platforms.

In one embodiment of the invention, a system manager discovers which components are interfaceable for high availability services and spawns a component management entity (“CME”) for each of the discovered components. According to one embodiment of the invention, the CME may exert relatively local control over the component and couple the component with the system manager through a set of interfaces selected according to the characteristics of the component and the system. In one embodiment of the invention, the CME is spawned with an interface engine that selectively invokes functions to interface the component with the system manager. The system manager and the CME may each provide proactive platform management and failure recovery.

Certain embodiments of the invention interface a middleware software stack to a hardware stack, thus creating portability of middleware across may different hardware platforms and portability of hardware platforms across many different types of middleware modules.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

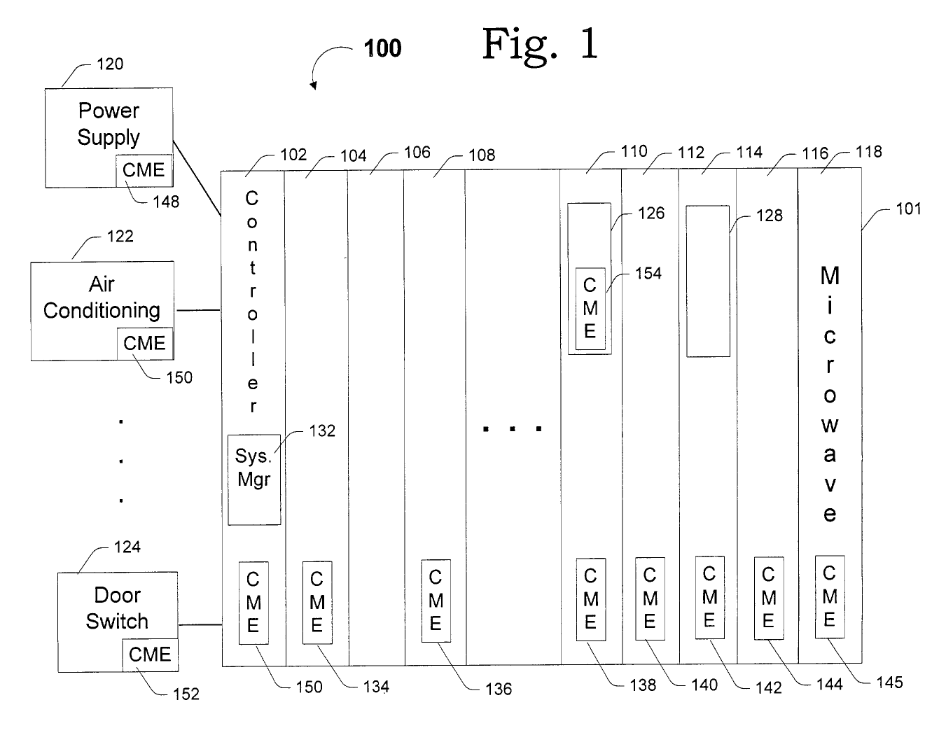

FIG. 1 is a block diagram of an example electronic system environment incorporating an embodiment of the invention. According to one example embodiment, electronic system environment 100 is depicted comprising a telecommunications system chassis 100 populated with a plurality of functional cards (or, blades) e.g., switching banks 104-116. A controller 102 also resides on a card and is communicatively coupled with the other cards to coordinate the system 100 through buses and hardwiring included in the system chassis 101. Cards having other useful functions may be present, such as a microwave communications card 118. Supporting peripheral devices and environmental devices are also included in the system 100, such as a power supply 120, an air-conditioning unit 122, and a cabinet door having a door switch 124. The switching banks 104-116, which may be regarded as components, may include devices such as removable chips, relays, indicator lights, and mezzanine cards 126, 128 that may in turn be regarded as components in their own right. Each of the switching banks 104-116 and the mezzanine cards 126, 128 may be swapped in and out of the system 100.

According to one embodiment of the invention, the example telecommunications system 100 is rendered highly available by component management entities (CMEs) 132-154 interfaced with selected components under the overall control of a system manager 130. Not every component is required to have an associated CME, for example a card 106 may be excluded from the high availability services. In the example system 100, the system manager 130 is incorporated in the controller 102, but in alternative systems the system manager 130 does not need to be associated with a controller 102.

In one embodiment of the invention, the system manager 130 discovers components present in the system 100 and selects components eligible for high availability. The discovery may entail, for instance, an inventory of components coupled with the system manager 130 through physical interfaces or may entail borrowing a list of system components from underlying system software. The discovery engine 226 produces or obtains a list of characteristics for each discovered component. The system manager 130 then spawns a CME for each component to be made highly available, tailoring aspects of the CME to the component characteristics, such as the component type and the component platform as well as to system characteristics, such as the system type and system conditions that affect the service availability of the component. The system manager 130 determines how much management autonomy to give to a particular CME. The system manager can also specify the manner in which the interface with the component is created. In one embodiment of the invention, the system manager 130 spawns the CME with a predetermined set of interfaces to be employed between the system manager 130 and the component. Alternatively, the system manager 130 can give the CME autonomy to create its own set of interfaces or to dynamically change interfaces when one component is swapped for another.

For a relatively simple component, such as the door switch 124, the associated CME 152 may be spawned with a simple predetermined set of interfaces and given a great deal of management control over the door switch 124. For example, if the door switch 124 is “open” at an undesirable time the CME 152 senses an “event” and may power a warning indicator light, increase a dwell time for the air conditioning unit 150 or take other preventative action without communicating with the system manager 130.

For a relatively complex component, such as the controller 102 of the example telecommunications system 100, the system manager 130 may spawn a CME 132 that relies a great deal upon the system manager 130 for management decisions. Additionally, the CME 132 may be spawned with its own interface engine that can selectively invoke functions to interface its associated component, the controller 102, with itself and with the system manager 130. For example, when the controller 102 is swapped out for an updated controller, the CME 132 may have the capability to dynamically add, subtract, or customize high availability management interfaces to match a new controller 102 having a new platform. An updated component may have its own high availability capabilities and may not need all the interfaces that the previous component required.

In one embodiment of the invention, a cascaded system of CMEs 126, 138 may be spawned for components located within other components so that the CME 126 most distil to the system manager 130 may receive management assistance from a CME 138 more proximal to the system manager 130 without accessing system manager 130 resources. For example, a CME 138 proximal to a mezzanine card 126 having its own CME 154 may power an LED indicating that it is safe to remove the mezzanine card 126 and other components from its switching bank 110. When the mezzanine card 126 is removed, the CME 138 proximal to the mezzanine card 126 may terminate or otherwise account for the absence of its assigned component and relay the removal event to the system manager 130. When the mezzanine card 126 is reinserted, the distil CME 154 most directly responsible for the mezzanine card 126 may reconfigure interfaces with the reinserted card and relay information about its new interfaces to the next proximal CME 138. The proximal CME 138 may reintegrate the reinserted mezzanine card 126 into the high availability management of the whole switching bank 110 based on communication with the distil CME 154 without having to expend system manager 130 resources. Thus, the cascading of CMEs may allow embodiments of the invention to be scaled to very large or very complex systems.

The example telecommunication system 100 is only one environment in which embodiments of the invention could be beneficially employed. Many other applications are possible, including computer and computer networking systems, automobiles, and consumer electronics.

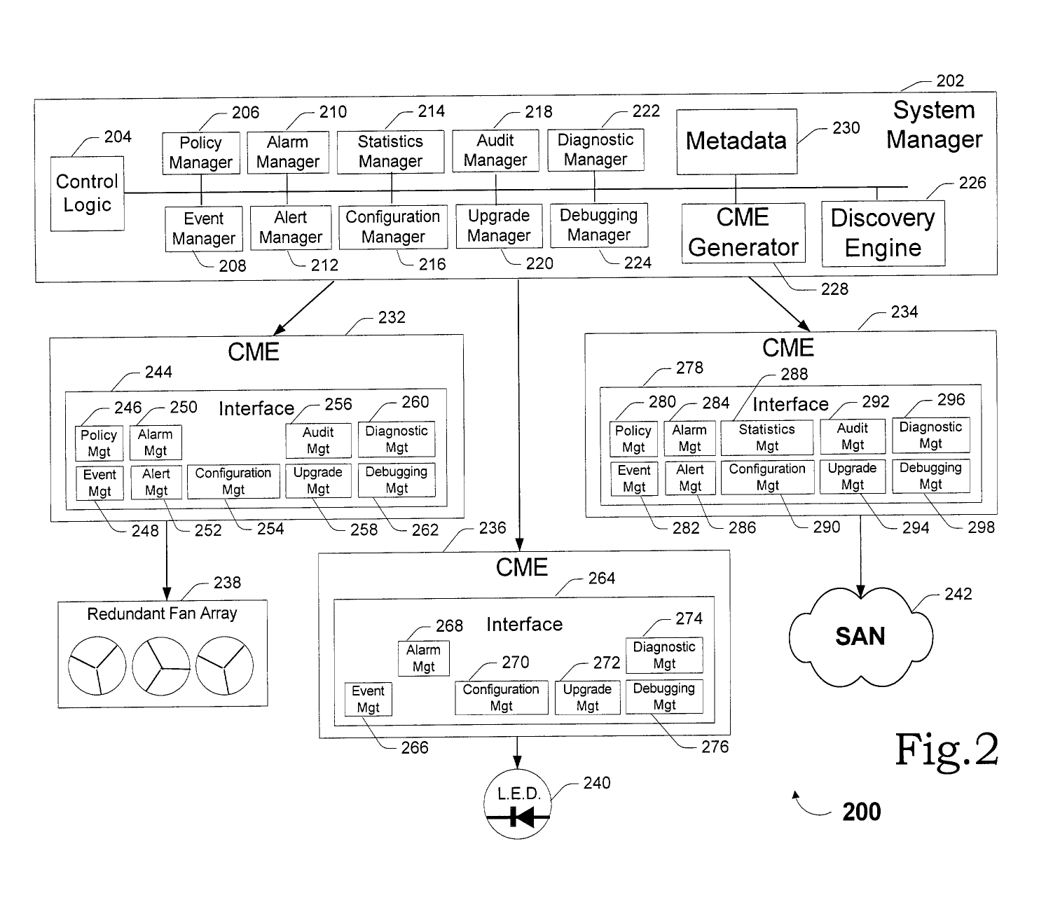

FIG. 2 is a block diagram of an example system manager 202, CMEs 232-236, and components 238-242 coupled together into a component management framework for high availability, according to one embodiment of the invention. A system manager 202 resides in a system 200 having a redundant fan array 238, an LED 240, and a storage area network (SAN) 242. The system manager 202 includes a discovery engine 226, a CME generator 228, and a source of metadata 230, communicatively coupled with control logic 204 as depicted. In one embodiment of the invention, the source of metadata 230 describes attributes and member functions for potential interfaces between the system manager 202 and components. Additionally, the system manager 202 includes a set of managers 206-224 relevant to high availability management, relevant to component interfaceability, or relevant to both.

In the illustrated embodiment of the invention, the system manager 202 is depicted comprising one or more of a policy manager 206, an event manager 208, an alarm manager 210, an alert manager 212, a statistics manager 214, a configuration manager 216, an audit manager 218, an upgrade manager 220, a diagnostic manager 222, and a debugging manager 224 communicatively coupled with control logic 204 as depicted.

Each manager or manager function in the system manager 202, as listed above, monitors and controls an aspect of high availability for components and CMEs. The list of managers is not meant to be comprehensive, but is a sample list of managers that can be selected to interface with a component using a dynamic interface according to one aspect of the invention. The policy manager 206 may administer policy, such as high availability rules, for example in one embodiment of the invention the policy manager 206 may turn on and off policy behaviors in a part of the system 200, or query to determine what policies have been enabled. Policy rules and data may be stored in a database, may be stored in the metadata 230, or may be received or updated from a source outside the system 200.

The event manager 208 may administer the sensing and in one embodiment of the invention the definition of occurrences that have relevance to service availability. An event is not necessarily a failure occurrence, but is any event, such as a change in condition, that causes the event manager 208 to take notice because of an effect or possible effect on service availability. Specifically, the event manager 208 may set or monitor thresholds that can define an event. For example, if a heat sensitive component reaches a particular temperature, the event manager 208 may decide to take action. The event manager 208 may also employ event gradients, for example, at various temperatures the heat sensitive device might trigger a minor event, a major event, or a critical event.

The alarm manager 210 and the alert manager 212 may react to triggered events by alerting other managers in the system manager 202 as well as entities outside the system 200, such as maintenance personnel, of failure, of approaching failure conditions, or of actions taken to prevent or repair a failure.

The statistics manager 214 may gather statistics that indicate a potential fault in a subsystem or a component. In one embodiment of the invention, the statistics manager 214 gathers computer networking information about failed data packets, that may indicate an area of weakness in the network, for example that a connection is approaching failure.

The configuration manager 216 may discover the configuration of hardware and software and change the configuration. In one embodiment of the invention, the configuration manager 216 discovers the status of each component in the high availability framework, and passes global impressions to the other managers in the system manager 202.

The audit manager 218 and the diagnostic manager 222 may query a component and perform tests to determine a state of health or a type of failure. In one embodiment of the invention, the audit manager 218 may monitor components at regular intervals and expect a certain reading to be returned. The diagnostic manager 222 may query a component and may consult diagnostic entities outside the system 200 for assistance in diagnosis.

The upgrade manager 220 may improve and exchange versions of components while the system 200 is running and available. In one embodiment of the invention, the upgrade manager 220 upgrades software while the system 200 is running and available while taking all precautions necessary to avoid crashes and unavailability.

The debugging manager 224 may make information, such as checkpoint data, statistical measurements, and repairs performed available to a technician. In one embodiment of the invention, the debugging manager 224 allows access to and debugging of the high availability framework itself.

Other modules may assist the various managers in the system manager 202. The discovery engine 226 performs an inventory of coupled components including both hardware and software components, or obtains a list of components present in the system 200, for example from underlying operating system software. Some embodiments of the invention may not require a discovery engine, for example an embodiment of the invention in a system having a standard set of unchanging components. The CME generator 228 uses the list of components to spawn CMEs 232, 234, 236 for the discovered components. In the illustrated embodiment of the invention, a single CME is spawned for each component. Alternatively, a single CME may interface with and manage more than one component, or one component may be managed by more than one CME.

In the illustrated embodiment, the CME 232 spawned for the redundant fan array 238 is endowed with an interface 244 lacking an interface to the statistics manager 214 of the system manager 202, but otherwise having an example full set of interface functions. In this regard, the interface 244 of CME 232 is depicted comprising a policy management interface function 246, an event management interface function 248, an alarm management interface function 250, an alert management interface function 252, a configuration management interface function 254, an audit management interface function 256, an upgrade management interface function 258, a diagnostic management interface function 260, and a debugging management interface function 262.

The example CME 236 for the LED 240 may have an interface 264 with an even smaller set of interface functions 266-276 than the interface 244 for the redundant fan array 238. A single LED is a relatively simple component to manage for high availability compared to an array of LEDs having backup elements that might require an interface more closely resembling that of the redundant fan array 238. The CME 234 for the SAN 242 has a full contingent of interface functions 280-298 in the interface 278 because the SAN 242 is a complex component having many interacting characteristics that may affect service availability.

An interface function may be left out of an actualized interface for the CME 232 if the system manager 202, for example, determines that the respective interface function is not possible for the component type or not useful for providing high availability services to the system 200. In one embodiment of the invention, a CME may be endowed with its own interface engine to configure and/or spawn an appropriate interface between the component and the system manager 202 and/or between the component and itself, as will be discussed more fully below.

The particular interface 244 actualized in the CME 232 may be created using metadata 230. In one embodiment of the invention, the metadata 230 is a class library from which CME and/or interface objects, such as application program interfaces (APIs), can be created as needed. In one embodiment of the invention, interfaces 244, 264, 278 are sets of APIs. Thus, the metadata 230 may be attributes, methods, and relationships that describe the possible interfaces and/or interface functions between possible system managers, possible CMEs, and possible components. In other words, a particular system manager 202 may have different characteristics than a system manager in another system, CMEs may have varying characteristics, and components being managed to achieve high availability are of different component types and may be of various platforms. The metadata 230 contains information to create interfaces between various types of system managers, various types of CMEs 232, 234, 236, and various types of components 238, 240, 242.

Alternatively, an exhaustive library of interfaces, interface parts, interface functions, and interface function parts may be used in conjunction with or in place of the metadata 230. The parts, being atomic building blocks of a high availability management system, may be rearranged in many combinations to create an interface or a set of interface functions between many different possible system managers, CMEs, and components.

In some embodiments of the invention, besides metadata 230 relating to interfaces, a set of widely or universally applicable rules, algorithms, and/or policies for achieving high availability in many types of systems may be stored in a library or abstracted in a set of rules metadata accessible by the set of managers 206-224 within the system manager 202.

In one embodiment of the invention, a CME 232, for example the CME 232 for the redundant fan array 238, may be endowed with management decision-making ability, instead of being created to depend on the system manager 202 for all management decisions. Thus, if the redundant fan array 238 comprises two active fans and one backup fan, the CME 232 may monitor all three fan elements and activate the backup fan upon failure of an active fan without accessing or referring to the system manager 202.

In one embodiment of the invention, if a CME 232 has the capability to perform autonomous recovery for its associated component, it will do so, but if no self-recovery is possible, the CME 232 notifies the system manager 202. The CME 232 may contain an interface, such as the diagnostic management interface 260 that allows the system manager 202 to query the component. The CME 232 may contain another interface, such as the configuration management interface 254 that allows the system manager 202 to reconfigure the component for fault analysis and recovery action.

A CME 232 is best suited to a component having various physical and operational features that can be monitored and maintained (or, that can fail), if the interface 244 can allow proactive “health checks,” by monitoring and detecting faults and anomalies in its associated component. Where applicable (or possible), the CME 232 may also set a threshold of distress, which when surpassed, triggers a signal or other indication to the system manager 202 that the component is starting to degrade or coming upon failure conditions. If no self-recovery is possible, the CME 232 has the capability of informing the system manager 202 to take preemptive or remedial action to maintain service availability for the component or the system 200 as a whole.

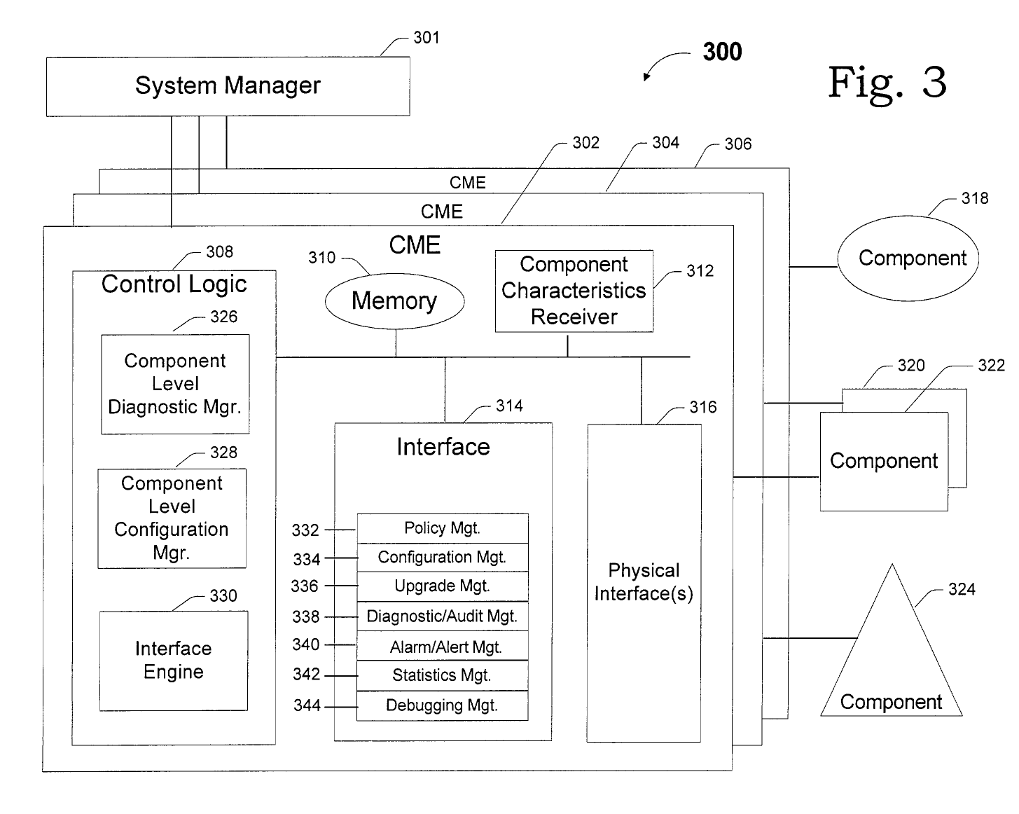

FIG. 3 is block diagram of an example system 300 having example CMEs, according to one embodiment of the invention. A first CME 302 interfaces a single component 320 with a system manager 301. A second CME 304 interfaces two components 322, 324 with the system manager 301. A third CME 306 interfaces a single component 318 with the system manager 301.

The first CME 302 includes an interface 314 comprising high availability management functions 332-344, physical interfaces 316, and memory 310 communicatively coupled with control logic 308 as illustrated. In one embodiment of the invention, the CME 302 may also include a component characteristics receiver 312 coupled with the control logic 308, and in one embodiment the control logic 308 may be endowed with a component level interface engine 330 and component level managers, such as a component level diagnostic manager 326 and a component level configuration manager 328. The physical interfaces 316 may include various types of ports, channels, and connections convenient for coupling with components, for example direct memory access (DMA) channels and universal serial bus (USB) ports.

The illustrated example CME 302 is configured/created to autonomously perform many of the management functions beneficial for achieving a high availability system 300. A single component 320 coupled with one or more physical interfaces 316 on the CME 302 has characteristics that may be sensed or received by the component characteristics receiver 312. For example, if the component 320 is an LED the component characteristics receiver 312 may possess power of control over the voltage and amperage that can be supplied to the LED so that continuity tests may be made to yield information about the characteristics of the LED. Alternatively, the component characteristics receiver 312 receives data about the LED's characteristics from a list of onboard components kept by the system manager 301. If the component 320 is more complex, for example a hard drive, the component characteristics receiver 312 may be provisioned to detect and adapt the interface to changes in the hard drive type and model when the hard drive is upgraded without accessing the system manager 301 for management assistance.

The characteristics received by the component characteristics receiver 312 may be utilized by the interface engine 330. Thus, the interface engine 330 will create a management function interface 314 for a hard drive “component type” and for the particular hard drive platform. The interface engine 330 may also take into account characteristics of the system 300, such as the system type and system conditions. A system condition is any parameter that affects interfaceability of a component and/or service availability of the component.

When the component 320 begins to approach failure conditions, the component level diagnostic manager 326 aboard the CME 302 may sense impending failure and send information to the onboard component level configuration manager 328 to attempt a preventative reconfiguration of the component 320. The diagnosis and attempt at reconfiguration are carried out in the CME 302 without assistance from the system manager 301. If the preventative attempt fails, the CME 302 may send a distress signal to the system manager 301, which may query the component 320 using the diagnostic management function 344 of the interface 314. The system manager 301 may decide that the component 320 needs to be replaced and send an indication to repair personnel. The system manager 301 might then make changes in the system 301 that allow the system 301 to continue in service while the component 320 is being swapped out, and activate an indicator near the component 320 informing repair personnel that the component can now be safely removed without compromising the availability of the system 301.

As discussed above with reference to FIG. 2, CMEs 302, 304, 305 may be spawned with varying abilities to create interfaces and solve problems autonomously. In one embodiment of the invention, a CME has no ability to create an interface autonomously, and may have little management control over the component. Such a CME may perform the same monitoring functions that more complex CMEs perform, but management and interface configuration is performed by the system manager 301.

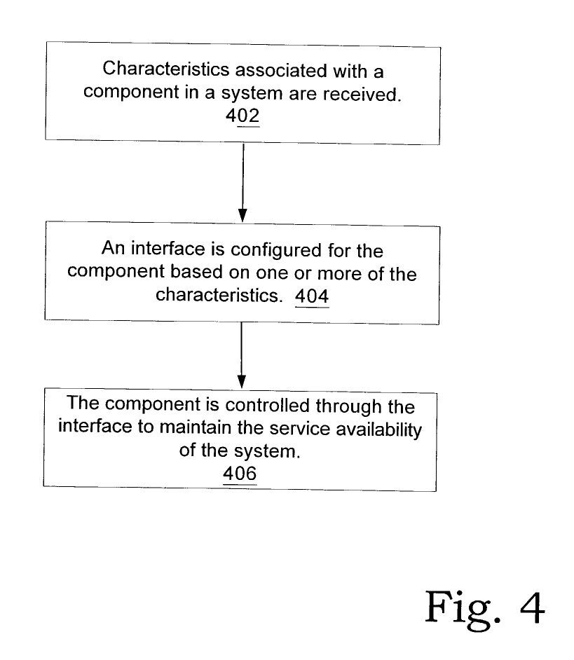

FIG. 4 is a flowchart of an example method embodiment of the invention. Characteristics associated with a component in a system are received 402. The characteristics may include the component type: for example a fuse is one type of component and an operating system is another type of component. The characteristics may also include the component platform: for example two hard drives may employ completely different data storage technologies requiring disparate interfaces. Characteristics associated with a component may also include system characteristics and system conditions. For example, a computer system installed in an off-road vehicle might require the gathering of more statistics related to parts failure than a computer system that controls stationary refrigeration units.

An interface is configured for the component based on one or more of the characteristics 404. The interface configuration may include selecting one or more programmatic interfaces from a set of programmatic interfaces and may also include creating one or more of the programmatic interfaces from a collection or class of interface metadata. Because the set of programmatic interfaces and/or the metadata can be comprehensive, embodiments of the invention are portable between many different types of hardware and software platforms.

The component is controlled through the interface to maintain the service availability of the system 406. When service availability of a component is maintained the component becomes a high availability component. If the maintenance is continuous, the component may achieve continuously available service. The type of control that may be performed through the interface includes, for example, monitoring the component (receiving feedback), configuring the component, upgrading the component, diagnosing a problem of the component, auditing a performance of the component, setting an alert for a condition of the component, obtaining statistics about the component, and debugging the component. Other types of control may be exerted over the component through the interface. The interface may comprise a set of interface functions reflecting the type of control desired for high availability.

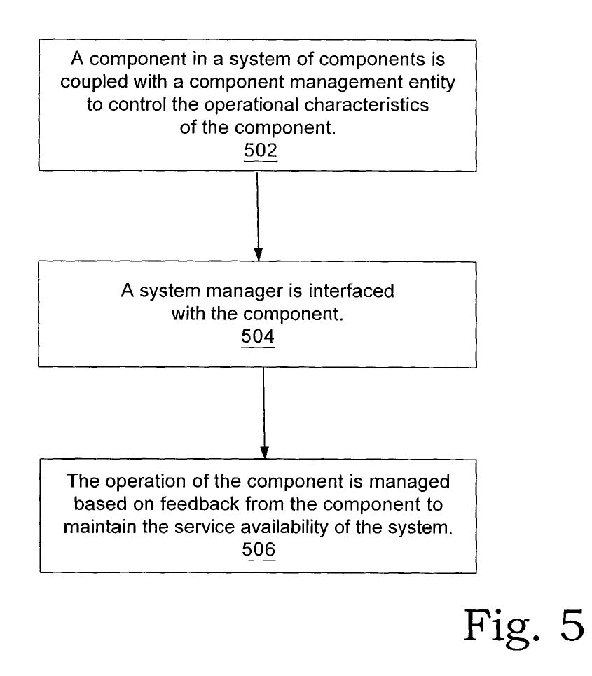

FIG. 5 is a flowchart of an example method of coupling a system manager and a CME with a component, according to one embodiment of the invention. A component in a system of components is coupled with a component management entity to control the operational characteristics of the component 502. A system manager is interfaced with the component 504. The operation of the component is then managed based on feedback from the component to maintain the service availability of the system 506. The method may also include discovering the component to interface with the system manager.

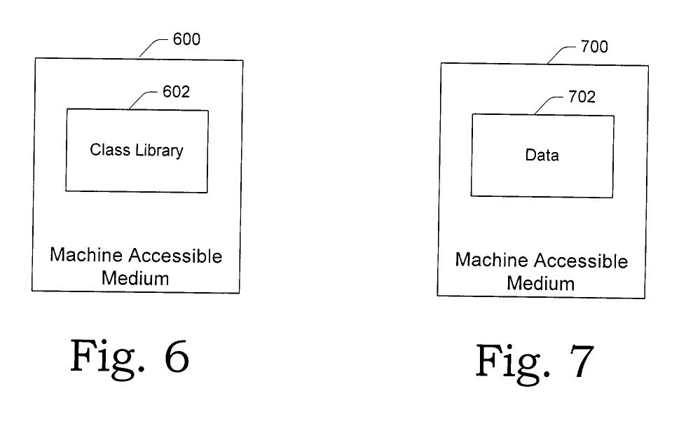

FIG. 6 is a graphical representation of an article of manufacture 600, comprising a machine-accessible medium containing a class library 602, that when accessed by a machine causes the machine to discover an interfaceable component in a system, wherein the component has characteristics and the system has characteristics; configure an interface for the interfaceable component based on one or more of the characteristics; and control the component through the interface to maintain the service availability of the system. The characteristics may include the component type, the component platform, the system type, or the system condition.

The class library may comprise attributes and methods of a policy management interface, a configuration management interface, an upgrade management interface, a diagnostic management interface, an alert management interface, a statistics management interface, and a debugging management interface. The configuration of the interface may be made by selectively invoking interface attributes and methods suitable for the component and the system, based on the characteristics of the component and the system.

FIG. 7 is a graphical representation of an article of manufacture 700, comprising a machine-accessible medium containing data 702, that when accessed by a machine cause the machine to receive characteristics affecting an interfaceability and a service availability of a component in a system, configure an interface for the component based on one or more of the characteristics, and control the component through the interface to maintain the service availability of the system. The characteristics may include the component type, the component platform, the system type, and the system condition.

The methods, systems, modules, and article of manufacture embodiments of the invention may be provided partially as a computer program product that may include the machine-readable medium. The machine-readable medium may include, but is not limited to, floppy diskettes, optical disks, CD-ROMs, magneto-optical disks, ROMs, RAMs, EPROMs, EEPROMs, magnetic or optical cards, flash memory, or other type of media suitable for storing electronic instructions. Moreover, parts of some embodiments of the invention may also be downloaded as a computer program product, wherein the program may be transferred from a remote computer to a requesting computer by way of data signals embodied in a carrier wave or other propagation media via a communication link (e.g., a modem or network connection). In this regard, the article of manufacture may well comprise such a carrier wave or other propagation media.

The methods, systems, modules, and articles of manufacture are described above in their most basic forms but modifications could be made without departing from the basic scope of the invention. It will be apparent to persons having ordinary skill in the art that many further modifications and adaptations can be made. The particular embodiments are not provided to limit the invention but to illustrate it. The scope of the invention is not to be determined by the specific examples provided above but only by the claims below.

What is claimed is:

1. A system, comprising:
a plurality of system components having component management entities (CMEs) to at least monitor one or more operational characteristics of the respective components; and
a system manager, coupled with the plurality of system components, to interface with the CMEs of at least a subset of the plurality of system components and to manage operation of and interaction between at least the subset of system components based on feedback from the CMEs.

2. The system of claim 1, wherein the system manager further includes one of a policy manager, an event manager, a configuration manager, an upgrade manager, a diagnostic manager, an auditing manager, an alert manager, an alarm manager, a statistics manager, and a debugging manager.

3. The system of claim 1, wherein the system manager further comprises a component discovery engine coupled with a CME generator, wherein the CME generator has access to interface attribute metadata.

4. The system of claim 1, wherein the system components include one of hardware and software.

5. The system of claim 1, wherein each component management entity further comprises:
control logic; and
an interface engine including one or more functions selectively invoked by the control logic to interface the system manager with each of the plurality of system components, based on one or more characteristics affecting one of an interfaceability and a service availability of the component.

6. The system of claim 5, further comprising a two component management entities cascaded in series between the system manager and the component.

7. The system of claim 5, wherein the functions include one of a policy management interface, an event management interface, a configuration management interface, an upgrade management interface, a diagnostic management interface, an audit management interface, an alert management interface, an alarm management interface, a statistics management interface, and a debugging management interface.

8. The system of claim 5, wherein the characteristics include one of a component type, a component platform, a system type, and a system condition.

9. A system, comprising:
a manager having access to a set of high availability (HA) rules to provide an HA service for the system; and
a self-configuring interface having a set of member functions from a class library of high availability interface attributes and methods to couple the manager with a component in the system.

10. The system of claim 9, wherein the member functions are selected based on characteristics of the component and characteristics of the system.

11. The system of claim 10, wherein the characteristics include one of a component type, a component platform, a system type, and a system condition.

12. The system of claim 8, wherein the component is one of hardware and software.

13. A component management entity for a system of components, comprising:
control logic; and
an interface engine including one or more functions selectively invoked by the control logic to interface a system manager with the component based on one or more characteristics affecting one of an interfaceability and a service availability of the component.

14. The component management entity of claim 13, further comprising a receiver to input the characteristics.

15. The component management entity of claim 13, wherein the characteristics include one of a component type, a component platform, a system type, and a system condition.

16. The component management entity of claim 13, wherein the one or more functions comprise application program interfaces.

17. The method of claim 16, wherein the application program interfaces have class attributes and member functions from a class library for high availability.

18. The component management entity of claim 13, wherein the one or more functions include a policy management interface function to interface a policy manager in the system manager or in the component management entity with the component.

19. The component management entity of claim 13, wherein the one or more functions include a configuration management interface function to interface a configuration manager in the system manager or in the component management entity with the component.

20. The component management entity of claim 13, wherein the one or more functions include an upgrade management interface function to interface an upgrade manager in the system manager or in the component management entity with the component.

21. The component management entity of claim 13, wherein the one or more functions include a diagnostic management interface function to interface a diagnostic manager in the system manager or in the component management entity with the component.

22. The component management entity of claim 13, wherein the one or more functions include an alert management interface function to interface an alert manager in the system manager or in the component management entity with the component.

23. The component management entity of claim 13, wherein the one or more functions include a statistics management interface function to interface a statistics manager in the system manager or in the component management entity with the component.

24. The component management entity of claim 13, wherein the one or more functions include a debugging management interface function to interface a debugging manager in the system manager or in the component management entity with the component.

25. The component management entity of claim 13, wherein the component management entity controls the component to maintain the service availability of the system.

26. The component management entity of claim 25, wherein the component management entity receives an instruction from the system manager to control the component.

27. A method, comprising:
receiving characteristics associated with a component in a system;
configuring an interface for the component based on one or more of the characteristics; and
controlling the component through the interface to maintain the service availability of the system.

28. The method of claim 27, wherein the characteristics include one of a component type, a component platform, a system type, and a system condition.

29. The method of claim 27, wherein the configuring comprises selecting one or more programmatic interfaces from a set of programmatic interfaces.

30. The method of claim 27, wherein the configuring comprises creating one or more programmatic interfaces from interface metadata.

31. The method of claim 27, wherein the configuring further comprises creating one or more of a policy management interface, a configuration management interface, an upgrade management interface, a diagnostic management interface, an alert management interface, a statistics management interface, and a debugging management interface.

32. The method of claim 27, wherein the controlling comprises one of monitoring the component, configuring the component, upgrading the component, diagnosing a problem of the component, auditing a performance of the component, setting an alert for a condition of the component, obtaining statistics about the component, and debugging the component.

33. The method of claim 27, further comprising controlling the component according to a service availability policy.

34. A method, comprising:
coupling a component in a system with a component management entity to control the operational characteristics of the component;
interfacing a system manager with the component; and
managing the operation of the component based on feedback from the component to maintain the service availability of the system.

35. The method of claim 34, further comprising discovering the component to interface with the system manager.

36. The method of claim 34, further comprising creating an interface based on a characteristic affecting one of an interfaceability of the component and a service availability of the component.

37. The method of claim 36, wherein the characteristic is one of a component type, a component platform, a system type, and a system condition.

38. The method of claim 36, wherein generating an interface further comprises creating for inclusion in the interface one of a policy management interface, a configuration management interface, an upgrade management interface, a diagnostic management interface, an alert management interface, a statistics management interface, a debugging management interface, and a debugging management interface.

39. An article of manufacture, comprising:
a machine-accessible medium containing a class library, wherein the class library expresses attributes and methods of a high availability (HA) component management framework for a computing device.

40. The article of manufacture of claim 39, wherein the class library expresses attributes and methods to:
discover an interfaceable component in a system, wherein the component has characteristics and the system has characteristics;
configure an interface for the interfaceable component based on one or more of the characteristics; and
control the component through the interface to maintain the service availability of the system.

41. The article of manufacture of claim 40, wherein the characteristics include one of a component type, a component platform, a system type, and a system condition.

42. The article of manufacture of claim 40, further comprising attributes and methods to select for inclusion in the interface one of a policy management interface, a configuration management interface, an upgrade management interface, a diagnostic management interface, an alert management interface, a statistics management interface, and a debugging management interface.

43. The article of manufacture of claim 40, further comprising attributes and methods to perform one of monitoring the component, configuring the component, upgrading the component, diagnosing a problem of the component, auditing a performance of the component, setting an alert for a condition of the component, obtaining statistics about the component, and debugging the component.

44. An article of manufacture, comprising:
a machine-accessible medium containing data, that when accessed by a machine cause the machine to:
receive characteristics affecting an interfaceability and a service availability of a component in a system;
configure an interface for the component based on one or more of the characteristics; and
control the component through the interface to maintain the service availability of the system.

45. The article of manufacture of claim 44, wherein the characteristics include one of a component type, a component platform, a system type, and a system condition.

46. The article of manufacture of claim 44, further comprising data, that when accessed by a machine cause the machine to configure the interface by selecting one or more programmatic interfaces from a set of programmatic interfaces.

47. The article of manufacture of claim 46, wherein the set of programmatic interfaces include a policy management interface, a configuration management interface, an upgrade management interface, a diagnostic management interface, an alert management interface, a statistics management interface, and a debugging management interface.

48. The article of manufacture of claim 47, further comprising data, that when accessed by a machine cause the machine to perform one of monitoring the component, configuring the component, upgrading the component, diagnosing a problem of the component, auditing a performance of the component, setting an alert for a condition of the component, obtaining statistics about the component, and debugging the component.

49. The article of manufacture of claim 44, further comprising data, that when accessed by a machine cause the machine to control the component according to a service availability policy.
